(19) United States
(12) Patent Application Publication
(10) Pub. No.: US 2026/0252695 A1
(43) Pub. Date: Aug. 27, 2026

(54) EXPLAINABLE ARTIFICIAL INTELLIGENCE SYSTEM FOR DETECTING MALICIOUS MEMORY

(71) Applicant: Zayed University, Dubai (AE)

(72) Inventors: Farkhund Iqbal, Abu Dhabi (AE); Mohd Saqib, Montreal (CA)

(73) Assignee: Zayed University, Dubai (AE)

(21) Appl. No.: 19/066,091

(22) Filed: Feb. 27, 2025

(51) Int. Cl. G06F 21/56

(52) U.S. Cl. CPC G06F 21/566; G06F 2221/034

(57) ABSTRACT

A method includes weighing a feature based on their relevance. The method includes analyzing, by the computing device, the feature. The analyzing includes using decision trees for classification. The decision trees classify one or more processes as being malicious and conducting counterfactual analysis. The method includes determining whether the feature is malicious.

### BACKGROUND

Memory dumps contain a vast amount of complex data, including numerous processes, executables, and features. Traditional deep learning algorithms often struggle with interpretability, making it difficult for analysts to trust or understand the decisions made by these models. Furthermore, the sheer volume of data can lead to the extraction of an overwhelming number of features, many of which may be irrelevant or redundant, complicating the analysis process.

The increasing sophistication of cyber-attacks demands innovative approaches to memory forensics, a critical aspect of cybersecurity. Memory forensics involves the analysis of volatile data (e.g., RAM dumps) to uncover malicious activities that leave little or no trace on disk. Existing methods, while effective, often lack interpretability, making it difficult for security analysts to understand the rationale behind detection results.

### BRIEF DESCRIPTION OF DRAWINGS

FIG. 1 is a diagram of an example flow process;

FIG. 2 is a diagram of an example flow process;

FIG. 3 is a diagram of an example table;

FIGS. 4 and 5 are diagrams of example tables;

FIG. 6 is a diagram of an example flow process;

FIG. 7 is a diagram of an example flow process;

FIG. 8 is a diagram of an example flow process;

FIG. 9 is a diagram of an example networking environment; and

FIG. 10 is a diagram of an example computer.

### DETAILED DESCRIPTION OF PREFERRED EMBODIMENTS

The following detailed description refers to the accompanying drawings. The same reference numbers in different drawings may identify the same or similar elements.

Systems, devices, and/or methods described herein are for analyzing computer memory and determining if there is any malicious memory dumps present. In embodiments, the described analysis system can determine malicious memory dumps by using a hierarchical, tree-based approach that integrates domain knowledge at every level of analysis. In embodiments, the analysis system has a particular hierarchical structure which allows for a detailed layer-by-layer analysis based on the memory dump having a “tree” structure where each node corresponds to a process, executable, feature, or values.

In embodiments, at each level of the tree design of the analysis system, features are weighted based on their relevance, as determined by domain knowledge. In embodiments, the weighting helps prioritize critical features associated with malicious activities, ensuring they are not overlooked. In embodiments, the analysis system uses an interpretable AI Model. In embodiments, the analysis system utilizes decision trees for classification, providing clear, interpretable paths that explain why certain processes or executables were flagged as malicious. In embodiments, this transparency is crucial for building trust in AI-driven security solutions. In embodiments, the analysis system also conducted counterfactual analysis which explores how changes in specific features could affect the maliciousness score, further enhancing the interpretability of the results.

Memory dumps contain highly heterogeneous and dense data, making the analysis for cyber forensics both time consuming and challenging. To address these complexities, the described analysis system is a specialized explainable artificial intelligence (XAI) solution designed for memory dump analysis that emphasizes both detection accuracy and explainability. In embodiments, the described analysis system can handle the intricacies of memory data, providing a structured and interpretable approach through tree traversal combined with domain-specific knowledge integration. In embodiments, the analysis system can identify malicious processes with an overall accuracy of 99.83%, with a precision of 0.98% for malware processes, and an F1-score of 0.99 for both classes. In embodiments, these metrics highlight the analysis system's capability to accurately differentiate between benign and malicious activities, ensuring reliable results in forensic investigations.

Furthermore, the analysis system achieves higher sparsity values (e.g., 0.5412 average score of 400 files) which indicates that the analysis system provides more concise and focused explanations. In embodiments, this level of sparsity is crucial when dealing with memory dumps, as it allows analysts to isolate critical information without being overwhelmed by irrelevant details. Additionally, the analysis system achieves a fidelity score of 0.6083, surpassing both LIME (0.5675) and SHAP (0.5817), which demonstrates that the explanations generated by the analysis system more accurately reflect the underlying model's decisions, enhancing trustworthiness.

Accordingly, the analysis system is a hierarchical model designed to analyze and interpret memory dumps by leveraging tree-traversal, domain knowledge, and machine learning techniques. In embodiments, the model organizes the memory dump into a tree structure, where each node represents processes, executables, and their associated features. This hierarchical structure allows for a detailed examination of the memory dump, facilitating the identification of malicious behavior.

In embodiments, the entire memory dump can be represented as a set of processes, M={P₁, P₂, . . . , Pₙ}, where Pᵢ denotes the i-th process within the memory dump. Each process Pᵢ consists of a set of executables, Pᵢ={Eᵢ₁, Eᵢ₂, . . . , Eᵢₘ}, where Eᵢⱼ represents the j-th executable in the i-th process. Each executable Eij can be decomposed into a set of features, Eᵢⱼ={fᵢⱼ₁, fᵢⱼ₂, . . . , fᵢⱼₖ}, where fijk denotes the k-th feature of executable Eᵢⱼ.

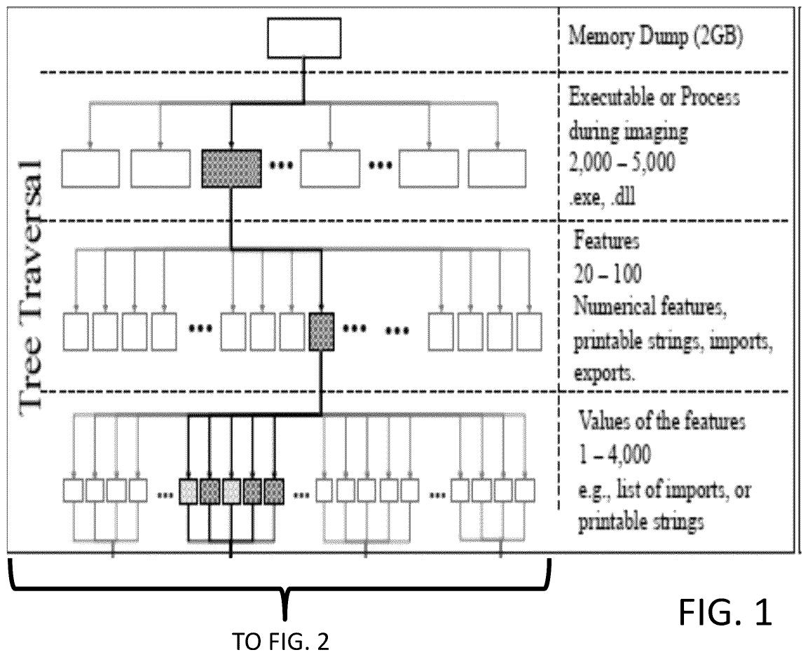

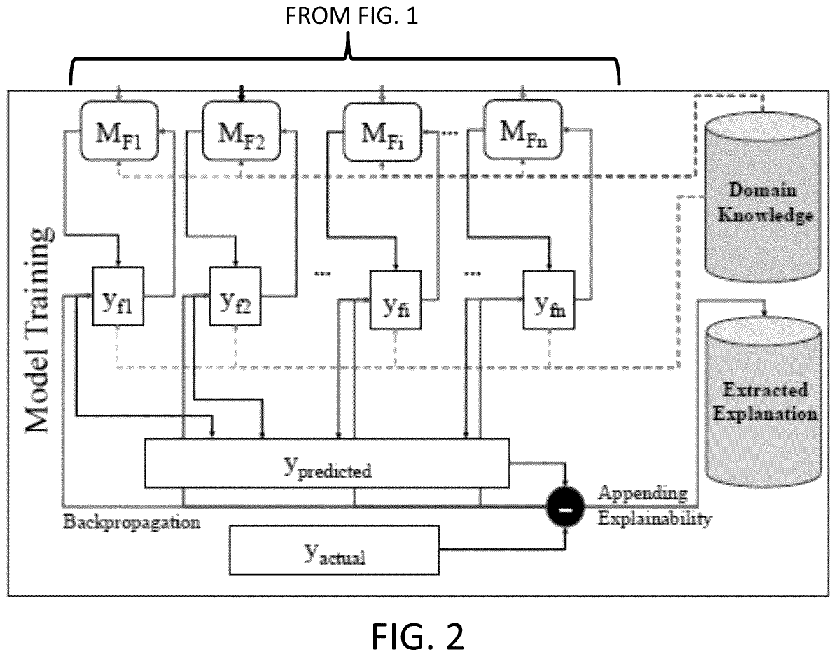

FIGS. 1 and 2 describe a hierarchical structure of the memory dump can be represented as a tree T where the root node r represents the entire memory dump M, intermediate nodes nᵢⱼ represent processes Pᵢ and executables Eᵢⱼ, and leaf nodes lᵢⱼₖ correspond to features fᵢⱼₖ. In embodiments, the tree traversal algorithm A_{T}(T) explores this structure, typically modeled as a depth-first search (DFS) traversal: A_{T}(T)={T traversal sequence}.

In embodiments, the domain knowledge is incorporated at each level of the tree through a weight function w(fᵢⱼₖ) that assigns a score to each feature based on its relevance: w(fᵢⱼₖ): fᵢⱼₖ→R. In embodiments, the weight function is informed by a knowledge base K, which includes indicators of compromise (IOCs), typical malicious behaviors, and anomaly patterns. In embodiments, the final weighted feature for an executable Eᵢⱼ is:

$$W ( {E}_{ij} ) = {\sum }_{k = 1}^{\vert {E}_{ij} \vert} w ( {f}_{ijk} ) \cdot {f}_{ijk}$$

For each node in the tree, construct a feature vector Xᵢⱼ consisting of the weighted features:

$${X}_{ij} = [ w ( {f}_{ij 1} ) , w ( {f}_{ij 2} ) , … , w ( {f}_{ijk} ) ]$$

In embodiments, a model M, as used by the analysis system, (e.g., Random Forest, Gradient Boosting, Neural Network) is trained to classify whether a process or executable is malicious based on the feature vector:

$$M : {X}_{ij} \to \{ 0 , 1 \}$$

In embodiments, 0 indicates benign and 1 indicates malicious. We perform cross-validation to evaluate the model's performance and adjust the model's hyperparameters based on the validation results to optimize accuracy and reduce false positives/negatives. Let yᵢⱼ be the label (0 for benign, 1 for malicious) associated with executable Eᵢⱼ or process Pᵢ. The goal is to train the model M to minimize the difference between its predicted output ŷᵢⱼ=M(Xᵢⱼ) and the true label ŷᵢⱼ as shown in FIG. 2.

In embodiments, the aggregation of the scores of the executables within process Pi is performed using a weight αᵢⱼ that reflects the importance of each executable's features based on domain knowledge:

$${α}_{ij} = \frac{1}{Z} {\sum }_{k = 1}^{\vert {E}_{ij} \vert} w ( {f}_{ijk} )$$

where

$$Z = {\sum }_{j = 1}^{{m}_{i}} {\sum }_{k = 1}^{\vert {E}_{ij} \vert} w ( {f}_{ijk} )$$

is a normalization factor ensuring that the sum of weights across all executables equals 1. If fᵢⱼₖ is a critical feature (e.g., associated with a known vector, w(fᵢⱼₖ) is high, making αᵢⱼ large, thus increasing the impact of ŷᵢⱼ on the process-level score.

In embodiments, the process-level prediction with domain knowledge integration becomes:

$${\hat{y}}_{i} = {\sum }_{j = 1}^{{m}_{i}} {α}_{ij} {\hat{y}}_{ij}$$

In embodiments, this approach ensures that executables containing critical malicious features have a more significant impact on the final process-level prediction, reducing the risk of missing important signals. The loss for each process is calculated using the aggregated score

$${L}_{i} = [ {y}_{i} log ( {\hat{y}}_{i} ) + ( 1 - {y}_{i} ) log ( 1 - {\hat{y}}_{i} ) ]$$

In embodiments, the analysis system provides a robust framework for analyzing memory dumps by integrating domain knowledge into a hierarchical tree structure. In embodiments, the model's ability to weight features based on their relevance ensures that critical malicious signals are not overlooked, leading to more accurate and explainable predictions in memory forensics.

In a non-limiting example, the domain knowledge used for the analysis system was extracted from a total of 41,618 files, comprising 26,057 samples of malicious processes and 15,561 benign samples. In this non-limiting example, the data was split into a training set and a testing set using an 80-20 ratio, ensuring that the model had sufficient data for both training and evaluation.

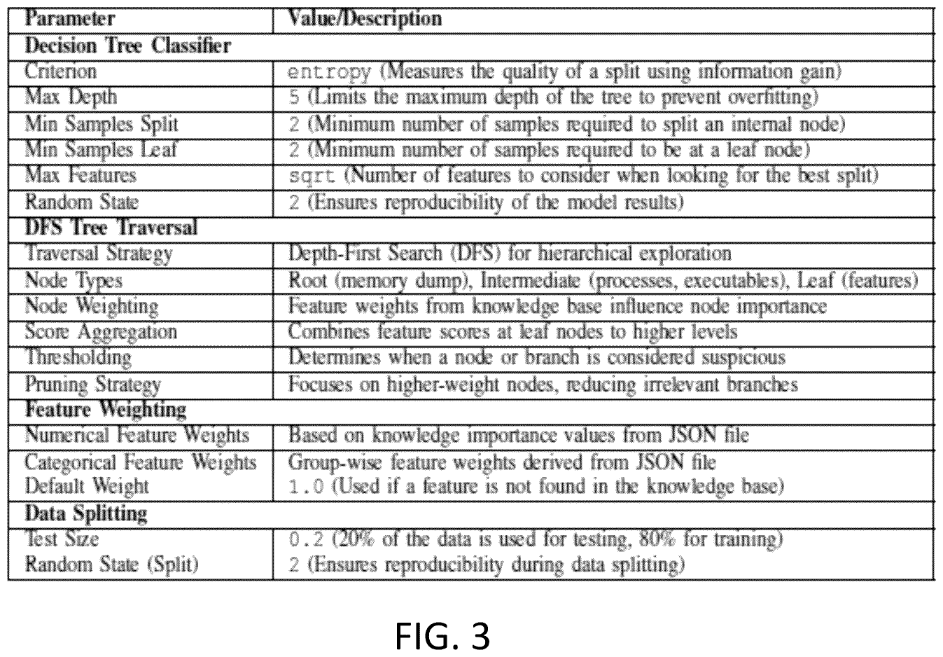

In embodiments, a Python library may be used which allows for extraction of key numerical features, API lists (imports and exports), and printable strings from the memory dumps. In embodiments, class-based features, such as categories of imports and exports, are encoded using label encoding and SBERT to prepare them for model training. In embodiments, other numerical and textual features are directly incorporated into the analysis. In embodiments, the model's parameters and hyperparameters, including those used for feature weighting, the decision tree classifiers, and the DFS traversal, are shown in a table described in FIG. 3. In embodiments, these parameters were carefully tuned to ensure that analysis system effectively prioritizes indicators of compromise (IOCs) and balances the trade-off between detection accuracy and interpretability.

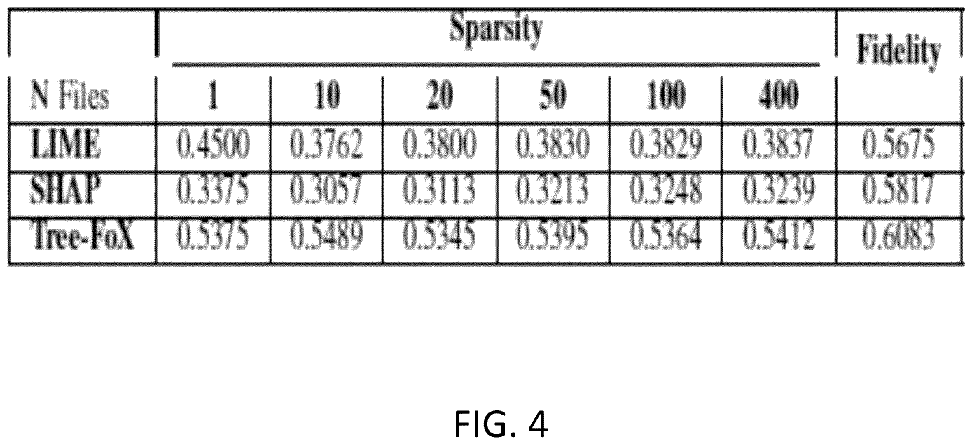

In embodiments, the classification and evaluated the performance metrics are conducted on the testing data, as shown in the table described in FIG. 4. As shown in FIG. 4, the analysis system demonstrates near-perfect accuracy in detecting malicious processes in memory dumps, with a high precision and recall across all classes. In embodiments, the results indicate that the analysis system is highly effective in identifying malicious activity, providing both accurate and reliable detection.

In embodiments, FIG. 4 also describes the classification and evaluated the performance metrics conducted on the testing data. In embodiments, the analysis system demonstrates near-perfect accuracy in detecting malicious processes in memory dumps, with a high precision and recall across all classes. The results indicate that the analysis system is highly effective in identifying malicious activity, providing both accurate and reliable detection.

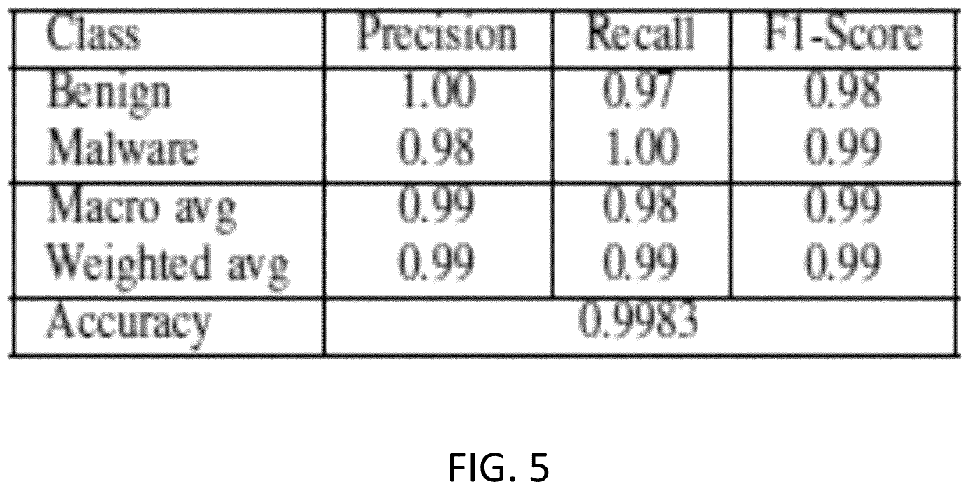

Given that most previous system for memory dumps primarily employ LIME and SHAP, a direct comparison of analysis system against these established techniques using sparsity and fidelity metrics are described in the table shown in FIG. 5. In embodiments, sparsity measures the conciseness of the explanations, with lower values indicating more compact outputs. However, memory dumps contain numerous features and values, making it difficult to isolate relevant information. In this context, a model that provides highly concise explanations with high sparsity is crucial for effective decision-making.

In embodiments, the analysis system demonstrates higher sparsity across all file numbers compared to LIME and SHAP, meaning it generates explanations that are more focused and precise. This is particularly important for memory forensics, where irrelevant details can obscure critical insights. In contrast, while LIME and SHAP offer more compact explanations, they may miss key features necessary for accurate forensic analysis (as shown in FIG. 5).

Fidelity, on the other hand, reflects how well the explanation model approximates the predictions of the original classifier, the analysis system achieves the highest fidelity score (0.6083), surpassing both LIME (0.5675) and SHAP (0.5817), which suggests that the analysis system explanations are more faithful to the underlying model's predictions (as shown in FIG. 5). In embodiments, this is crucial in high-stakes environments such as memory forensics, where the interpretability and explainability of model outputs must remain accurate to ensure trust in the system's decisions.

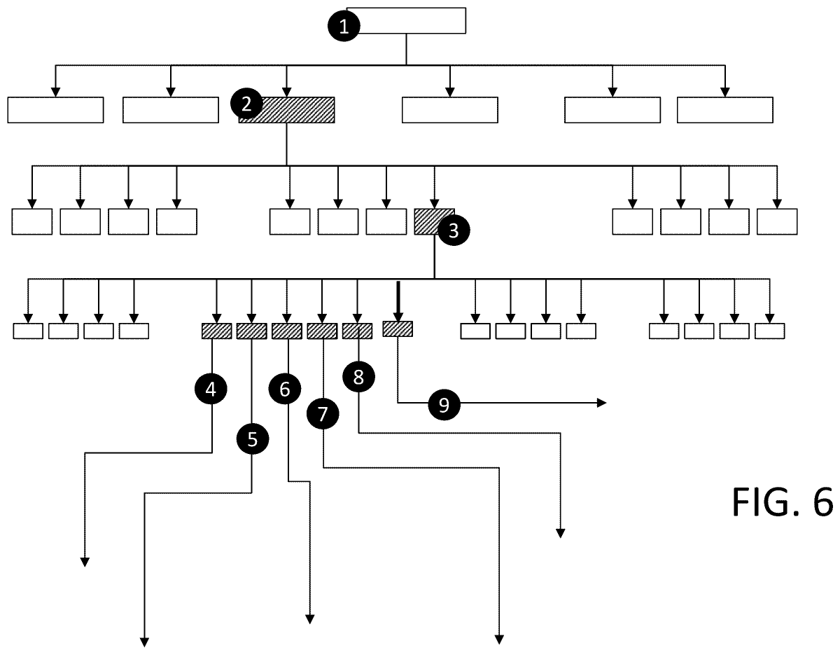

By using the process system, explainability features are extracted from the memory dump. Based on these features, three key points are identified that are crucial for making decisions in cyber forensics, particularly in court proceedings. This includes determining why a file is malicious. In embodiments, the initial analysis focuses on the extraction of numerical features from the executable, which provided critical insights into its potentially malicious nature. FIG. 6 describes an example node diagram regarding how the analysis system determines malicious memory by using a tree-type analysis. As shown in FIG. 6, the node diagram describes features of the analysis system in the context of numerical features. As shown in FIG. 6, node 1 represents the presence of a memory dump. Node 2 corresponds to a specific executable process that has malicious features while Node 3 denotes the feature. Nodes 4-9 represent the values of that feature.

For example, the following features were observed: at Node 4-ExportsNbDLL: 7, This feature indicates the presence of seven exports, which is atypical for non-DLL files. Malware often includes multiple exports to facilitate dynamic interaction with other components or to enable remote communication, data exfiltration, or execution of malicious code. As shown in FIG. 6, Node 5 is SectionsMean Entropy: 4.567, and Node 7 is ResourcesMeanEntropy: 4.9116. which are the mean entropies of the resources section is moderately high, suggesting that the resources may be encoded or compressed. This is a technique used by malware to evade static analysis. As shown in FIG. 6, Node 6 is Resources MeanSize: 381.0, which indicates a potentially anomalous resource section size, suggesting obfuscation, packing, or embedded payloads commonly seen in malware. As shown in FIG. 6, Node 8 is Sections-MaxEntropy: 6.62 which is a maximum entropy of the file's sections that is approaching the upper limit for benign files, potentially indicating the presence of packed or encrypted data, a hallmark of malicious software designed to evade detection. As shown in FIG. 6, Node 9 is “ImportsNb”: 120 indicates that the executable imports 120 API functions, which may suggest heavy reliance on system libraries, potentially for malicious activities like process injection, encryption, or persistence mechanisms.

In embodiments, the combination of these features-specifically, high export counts, elevated entropy, and a substantial number of imports-strongly suggests that the executable employs packing or obfuscation techniques, which are commonly used by malware to evade detection and execute malicious activities such as encryption or remote control.

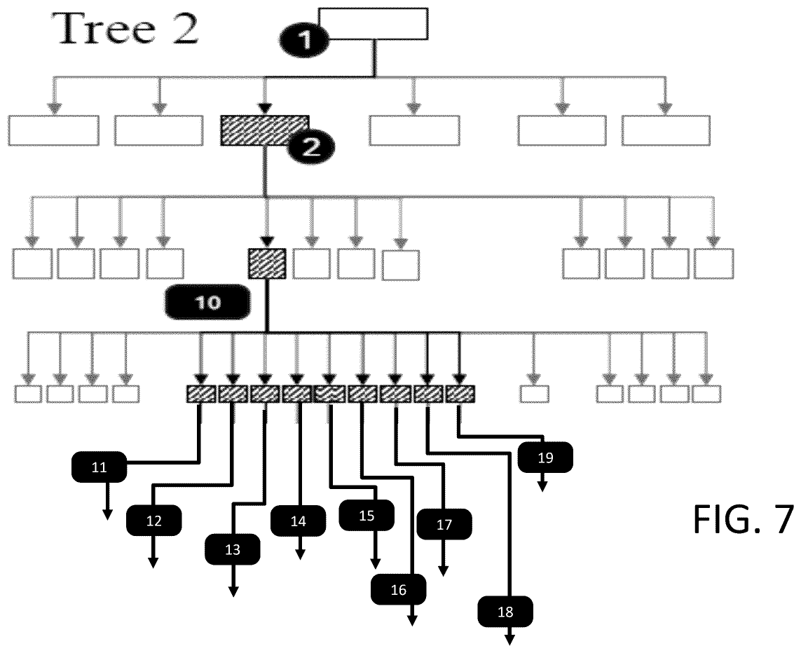

In embodiments, the analysis system also determines what malicious intent does the file have. In embodiments, the second part of the analysis examines the API imports and exports, as well as key strings that point to the executable's functionality which is shown in a tree format in FIG. 7. In embodiments, several cryptographic and system level functions were identified, suggesting that the executable is involved in encryption and system manipulation operations. As shown in FIG. 7, Node 10 represents the feature of API keys used in process 2 (what is process 2-does this mean the second part of the analysis?), while nodes 11-19 correspond to the extracted API keys. For example, Node 11 is a CryptGenKey and Node 12 is a CryptEncrypt which are both functions used to generate and encrypt data using cryptographic keys. Node 13 (CryptImportKey) indicates key import for encryption, common in ransomware. Node 14 (CryptReleaseContext) frees cryptographic resources after use. Node 15 (CryptGetKeyParam) retrieves key parameters, potentially for malicious encryption adjustments. Node 16 (CryptAcquireContextW) establishes a cryptographic context for key management. Node 18 (DestroyWindow) forcefully closes windows, likely to disable security tools or disrupt user actions. Additionally, Node 17 is CryptExportKey and Node 19 is a RegCloseKey which means that the malware is exporting cryptographic keys, potentially to a remote command-and-control server. Furthermore, the manipulation of the Windows registry through RegCloseKey indicates efforts to establish persistence, a behavior commonly associated with malware such as Poweliks and Emotet.

In embodiments, the presence of these cryptographic functions, alongside system manipulation APIs, indicates that the executable is designed to perform encryption operations consistent with ransomware—and may also be modifying system settings to maintain persistence on the infected host. The malware is not only encrypting files, likely as part of a ransomware attack, but is also altering system configurations to ensure it remains active even after system reboots or security interventions. Such persistence mechanisms are commonly employed by advanced malware families like Emotet and Poweliks, which use registry modifications, scheduled tasks, or service injections to evade removal.

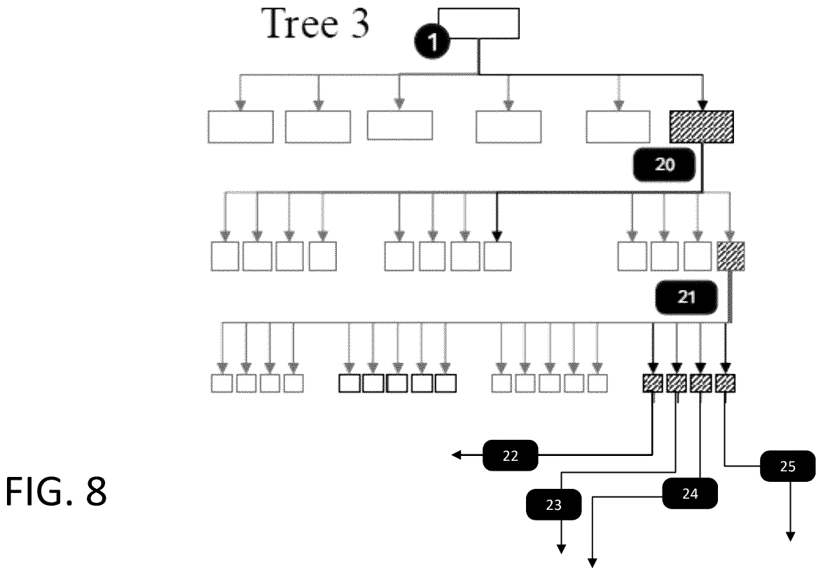

FIG. 8 describes an example node diagram that explains analyzing printable strings that may reveal one mor more suspicious sentences within software code. As shown in FIG. 8, nodes 21, 24, and 25 play crucial roles in identifying malicious behavior. For example, as shown in FIG. 8, Node 21 represents a significant branching point where the analysis detects the presence of suspicious API calls or cryptographic functions, marking a transition toward malicious intent. In embodiments, in FIG. 8, T Node 22 (“ransom_id”) is an indicator of ransomware activity, while Node 23 (“What are the odds that some idiot will name his mutex ether-rot-mutex!”) suggests the presence of a mutex, potentially used for ensuring single-instance execution, evasion, or persistence mechanisms in malware. As shown in FIG. 8, Node 24 contains a critical extracted string, such as “Uruchamianie InstallShield Wizard”, suggesting that the malware is masquerading as legitimate software to deceive users. As shown in FIG. 8, Node 25 contains another notable string, such as “Zamknij wszystkie uruchomione programy.” (translated: “Close all running programs.”), which further indicates an attempt to manipulate user activity, possibly forcing a system reboot or closing security applications to facilitate an attack. Thus, FIG. 8 shows how the analysis system's ability to trace malware intent using hierarchical forensic analysis, revealing both technical execution (encryption, API calls) and deceptive tactics (fake installer prompts, forced shutdowns) used by the malware.

In embodiments, the analysis system also identifies who is responsible for the attack. In embodiments, the analysis of printable strings extracted from the executable provides crucial insights into the intent and potential origin of the malware. The following strings are particularly relevant: (22) ransom id—This string is a clear indicator of ransomware, as it is commonly used by ransomware families such as Cerber and CryptoLocker to assign unique identifiers to victims. The presence of a ransom id string conclusively points to ransomware activity, as it is used to facilitate ransom payments and track victims. Furthermore, (23) ether-rot-mutex is a string refers to a mutex object used to ensure that only one instance of the malware runs at a time. The inclusion of this mutex, combined with its sarcastic and informal naming convention, is characteristic of many malware authors who intentionally leave mocking or taunting comments in their code.

For example, the executable may be masquerading as legitimate software targeting Polish-speaking users. Alternatively, the presence of Polish language strings may indicate that malware author is of Polish origin or the malware is specifically designed to target a Polish-speaking region. In embodiments, the combination of the ransomware-related string ransom id, the mutex reference ether-rot-mutex, and the use of Polish-language installation prompts enables us to attribute the attack with a high degree of confidence. In embodiments, the presence of ransom id alone indicates that the executable is likely ransomware, specifically designed to encrypt data and extort payment from victims.

Furthermore, the informal naming of the mutex suggests that the malware author is deliberately using techniques to mock or evade detection, a tactic commonly observed in cybercriminal groups. Therefore, the use of Polish language in the installation-related strings may either point to a Polish speaking attacker or to the malware being geographically targeted at Polish-speaking regions. Given the combined evidence, it is plausible to conclude that this executable is part of a ransomware campaign, potentially targeting Polish-speaking users, and that the attacker is either from Poland or has designed the malware to target that region specifically.

Based on the analysis of the numerical features, API calls, and printable strings, the executable is identified as ransomware with encryption capabilities and persistent system modifications. The attribution points to either a Polish speaking attacker or a campaign targeting Polish-speaking users, with the attacker's intent clearly focused on extortion through data encryption.

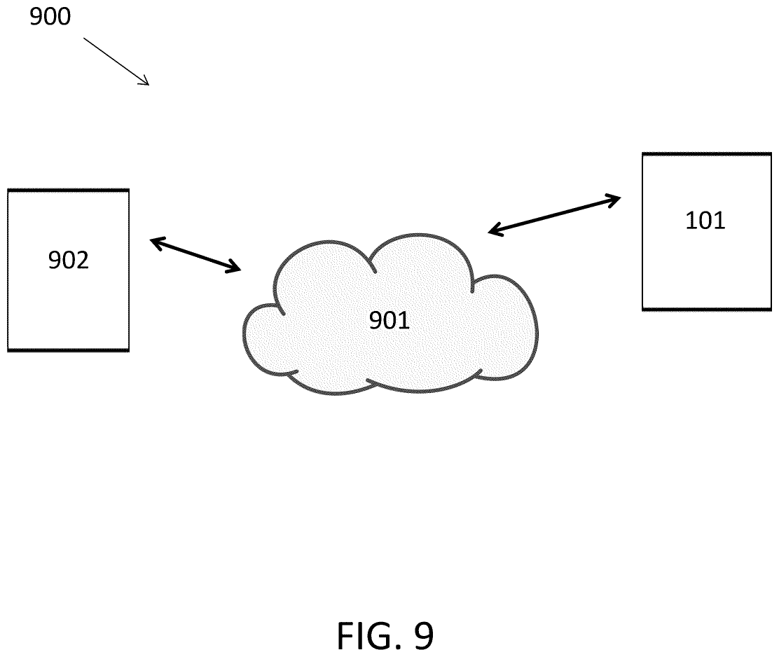

FIG. 9 is a diagram of example environment 900 in which systems, devices, and/or methods described herein may be implemented. FIG. 9 shows network 901, device 902, analysis system 101.

Network 901 may include a local area network (LAN), wide area network (WAN), a metropolitan network (MAN), a telephone network (e.g., the Public Switched Telephone Network (PSTN)), a Wireless Local Area Networking (WLAN), a WiFi, a hotspot, a Light fidelity (LiFi), a Worldwide Interoperability for Microware Access (WiMax), an ad hoc network, an intranet, the Internet, a satellite network, a GPS network, a fiber optic-based network, and/or combination of these or other types of networks. Additionally, or alternatively, network 901 may include a cellular network, a public land mobile network (PLMN), a second generation (2G) network, a third generation (3G) network, a fourth generation (4G) network, a fifth generation (5G) network, and/or another network.

In embodiments, network 901 may allow for devices to electronically communicate (e.g., using emails, electronic signals, URL links, web links, electronic bits, fiber optic signals, wireless signals, wired signals, etc.) with each other so as to send and receive various types of electronic communications.

Device 902 may include any computation or communications device that is capable of communicating with a network (e.g., network 901). For example, user device 902 may include a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a smart phone, a desktop computer, a laptop computer, a tablet computer, a camera, a personal gaming system, a television, a set top box, a digital video recorder (DVR), a digital audio recorder (DUR), a digital watch, a digital glass, or another type of computation or communications device.

User device 902 may receive and/or display content. The content may include objects, data, images, audio, video, text, files, and/or links to files accessible via one or more networks. Content may include a media stream, which may refer to a stream of content that includes video content (e.g., a video stream), audio content (e.g., an audio stream), and/or textual content (e.g., a textual stream). In embodiments, an electronic application may use an electronic graphical user interface to display content and/or information via user device 902. User device 902 may have a touch screen and/or a keyboard that allows a user to electronically interact with an electronic application. In embodiments, a user may swipe, press, or touch user device 902 in such a manner that one or more electronic actions will be initiated by user device 902 via an electronic application. User device 902 may receive electronic information from analysis system 101 and generate and display graphs such as those described in the figures above.

User device 902 may include a variety of applications, such as, for example, an e-mail application, a telephone application, a camera application, a video application, a multi-media application, a music player application, a visual voice mail application, a contacts application, a data organizer application, a calendar application, an instant messaging application, a texting application, a web browsing application, a blogging application, and/or other types of applications (e.g., a word processing application, a spreadsheet application, etc.). Analysis system 101 may include any computation or communications device that is capable of communicating with a network (e.g., network 701). In embodiments, analysis 101 may be similar to the analysis system described in regards to FIGS. 1 to 8.

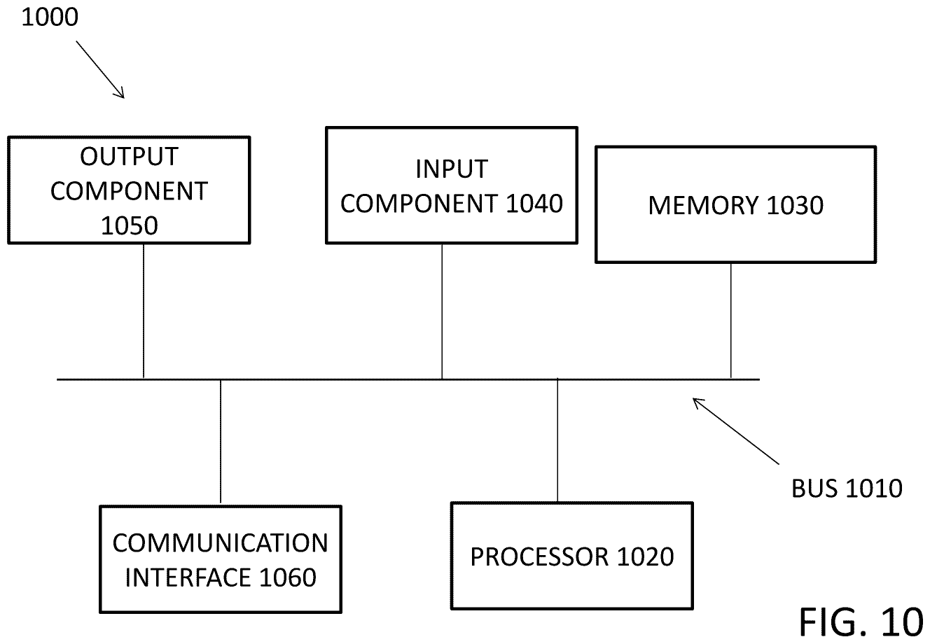

FIG. 10 is a diagram of example components of a device 1000. Device 1000 may correspond to user device 902, or analysis system 101. Alternatively, or additionally, user device 902 and analysis system 101 may include one or more devices 1000 and/or one or more components of device 1000.

As shown in FIG. 10, device 1000 may include a bus 1010, a processor 1020, a memory 1030, an input component 1040, an output component 1050, and a communications interface 1060. In other implementations, device 800 may contain fewer components, additional components, different components, or differently arranged components than depicted in FIG. 10. Additionally, or alternatively, one or more components of device 1000 may perform one or more tasks described as being performed by one or more other components of device 1000.

Bus 1010 may include a path that permits communications among the components of device 1000. Processor 1020 may include one or more processors, microprocessors, or processing logic (e.g., a field programmable gate array (FPGA) or an application specific integrated circuit (ASIC)) that interprets and executes instructions. Memory 1030 may include any type of dynamic storage device that stores information and instructions, for execution by processor 1020, and/or any type of non-volatile storage device that stores information for use by processor 1020. Input component 1040 may include a mechanism that permits a user to input information to device 1000, such as a keyboard, a keypad, a button, a switch, voice command, etc. Output component 1050 may include a mechanism that outputs information to the user, such as a display, a speaker, one or more light emitting diodes (LEDs), etc.

Communications interface 1060 may include any transceiver-like mechanism that enables device 1000 to communicate with other devices and/or systems. For example, communications interface 1060 may include an Ethernet interface, an optical interface, a coaxial interface, a wireless interface, or the like.

In another implementation, communications interface 1060 may include, for example, a transmitter that may convert baseband signals from processor 1020 to radio frequency (RF) signals and/or a receiver that may convert RF signals to baseband signals. Alternatively, communications interface 1060 may include a transceiver to perform functions of both a transmitter and a receiver of wireless communications (e.g., radio frequency, infrared, visual optics, etc.), wired communications (e.g., conductive wire, twisted pair cable, coaxial cable, transmission line, fiber optic cable, waveguide, etc.), or a combination of wireless and wired communications.

Communications interface 1060 may connect to an antenna assembly (not shown in FIG. 10) for transmission and/or reception of the RF signals. The antenna assembly may include one or more antennas to transmit and/or receive RF signals over the air. The antenna assembly may, for example, receive RF signals from communications interface 1060 and transmit the RF signals over the air, and receive RF signals over the air and provide the RF signals to communications interface 1060. In one implementation, for example, communications interface 1060 may communicate with network 901.

As will be described in detail below, device 1000 may perform certain operations. Device 1000 may perform these operations in response to processor 1020 executing software instructions (e.g., computer program(s)) contained in a computer-readable medium, such as memory 1030, a secondary storage device (e.g., hard disk, CD-ROM, etc.), or other forms of RAM or ROM. A computer-readable medium may be defined as a non-transitory memory device. A memory device may include space within a single physical memory device or spread across multiple physical memory devices. The software instructions may be read into memory 830 from another computer-readable medium or from another device. The software instructions contained in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While various actions are described as selecting, displaying, transferring, sending, receiving, generating, notifying, and storing, it will be understood that these example actions are occurring within an electronic computing and/or electronic networking environment and may require one or more computing devices, as described in FIG. 7, to complete such actions.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
weighing, by a computing device, a feature based on their relevance;
analyzing, by the computing device, the feature,
wherein the analyzing includes:
using decision trees for classification,
wherein, the decision trees classify one or more processes as being malicious, and
conducting counterfactual analysis;
determining, by the computing device, whether the feature is malicious.

2. The method of claim 1, wherein the feature is a memory dump, wherein the computing device classifies the memory dump as:
$$M = \{ P 1 , P 2 , … , Pn \} ,$$
where Pi denotes the i-th process within the memory dump.

3. The method of claim 2, wherein the Pi={Ei1, Ei2, . . . , Eim}, where Eij represents the j-th executable in the i-th process.

4. The method of claim 3, wherein the Eij can be decomposed into a set of features, Eij={fij1, fij2, . . . , fijk}, where the fijk denotes the k-th feature of executable Eij.

5. The method of claim 1, wherein domain knowledge is incorporated into the decision hierarchical tree structure.

6. A device, comprising:
memory,
and one or more processors to:
weigh a feature based on their relevance;
analyze the feature,
wherein the analyzing includes the one or processor to:
use decision trees for classification,
wherein, the decision trees classify one or more processes as being malicious, and
conduct counterfactual analysis; and
determine whether the feature is malicious.

7. The device of claim 6, wherein the feature is a memory dump, and wherein the device classifies the memory dump as:
$$M = \{ P 1 , P 2 , … , Pn \} ,$$
where Pi denotes the i-th process within the memory dump.

8. The device of claim 7, wherein the Pi={Ei1, Ei2, . . . , Eim}, where Eij represents the j th executable in the i-th process.

9. The device of claim 6, wherein domain knowledge is incorporated into the decision hierarchical tree structure.
